(19) United States
(12) Patent Application Publication
(10) Pub. No.: US 2010/0163318 A1
(43) Pub. Date: Jul. 1, 2010

(54) GOLF BAG CART

(75) Inventor: Paul Lin, Tainan Hsien (TW)

Correspondence Address: TUROCY & WATSON, LLP, 127 Public Square, 57th Floor, Key Tower, CLEVELAND, OH, 44114, US

(73) Assignee: MACAUTO INDUSTRIAL CO., LTD, Tainan Hsien (TW)

(21) Appl. No.: 12/346,541

(22) Filed: Dec. 30, 2008

(51) Int. Cl. B62D 51/04

(52) U.S. Cl. 180/19.1

(57) ABSTRACT

A golf bag cart includes a cart unit adapted for placing a golf bag thereon, a rear wheel unit connected to the cart unit, an electrically operable power front wheel unit coupled to the cart unit and disposed forwardly of the rear wheel unit, and an electric drive unit. The power front wheel unit is electrically operable to cooperate with the rear wheel unit for moving the cart unit on a ground surface. The power front wheel unit is coupled rotatably to the cart unit so as to be rotatable relative to the cart unit about a normal axis that is normal to the ground surface, thereby permitting change in direction of movement of the cart unit on the ground surface. The electric drive unit is disposed on the cart unit and is coupled to the power front wheel unit for driving rotation of the power front wheel unit about the normal axis.

### BACKGROUND OF THE INVENTION

1. Field of the Invention

This invention relates to a golf bag cart, and more particularly to an electrically operable golf bag cart.

2. Description of the Related Art

A conventional golf bag cart (not shown) includes a foldable cart frame, front and rear wheel units mounted on a bottom part of the cart frame, and an electric drive unit disposed on the cart frame and coupled to the rear wheel unit for driving rotation of the rear wheel unit to result in movement of the golf bag cart on a ground surface.

Because the aforementioned golf bag cart uses the electric drive unit to drive the rear wheel unit, the electric drive unit must be installed at a location that is close to the rear wheel unit. That is to say, the electric drive unit may interfere with folding movement of the cart frame, which results in a relatively large folded size of the golf bag cart that makes it inconvenient to store and transport.

### SUMMARY OF THE INVENTION

Therefore, the object of the present invention is to provide a golf bag cart that is capable of overcoming the above-mentioned drawback of the prior art.

According to this invention, a golf bag cart comprises a cart unit adapted for placing a golf bag thereon, a rear wheel unit connected to the cart unit, an electrically operable power front wheel unit coupled to the cart unit and disposed forwardly of the rear wheel unit, and an electric drive unit. The power front wheel unit is electrically operable to cooperate with the rear wheel unit for moving the cart unit on a ground surface. The power front wheel unit is coupled rotatably to the cart unit so as to be rotatable relative to the cart unit about a normal axis that is normal to the ground surface, thereby permitting change in direction of movement of the cart unit on the ground surface. The electric drive unit is disposed on the cart unit and is coupled to the power front wheel unit for driving rotation of the power front wheel unit about the normal axis.

### BRIEF DESCRIPTION OF THE DRAWINGS

These and other features and advantages of this invention will become apparent in the following detailed description of the preferred embodiment of this invention, with reference to the accompanying drawings, in which:

FIG. 1 is a perspective view of the preferred embodiment of a golf bag cart according to the present invention;

FIG. 2 is a schematic side view of the preferred embodiment to illustrate a folded state of the golf bag cart according to the present invention;

FIG. 3 is an exploded perspective view of a wheel support, an electric drive unit, and a front wheel unit of the preferred embodiment;

FIG. 4 is a perspective view to illustrate a connection relationship between the wheel support and a power supply unit of the preferred embodiment;

FIG. 5 is a schematic view of a pivot support of the preferred embodiment; and

FIG. 6 is a schematic side view to illustrate a connection relationship between the wheel support and the front wheel unit of the preferred embodiment.

### DETAILED DESCRIPTION OF THE PREFERRED EMBODIMENT

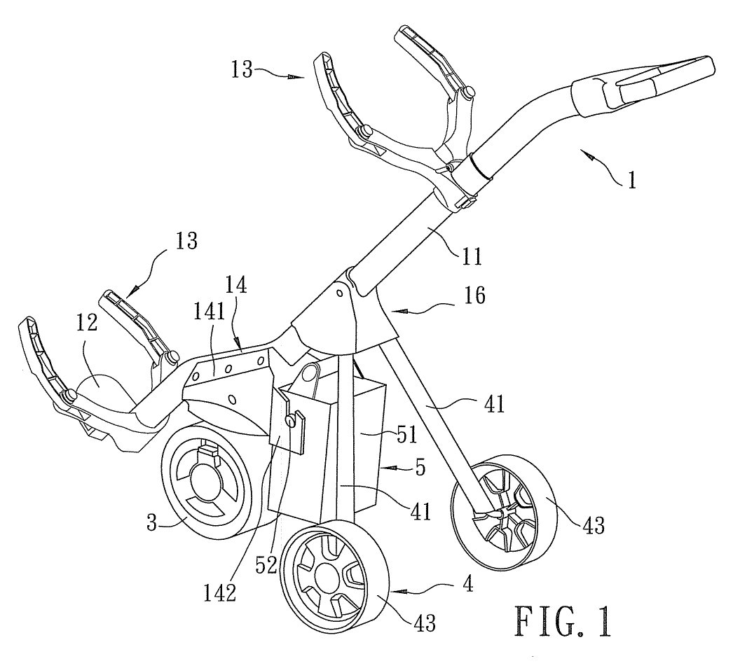

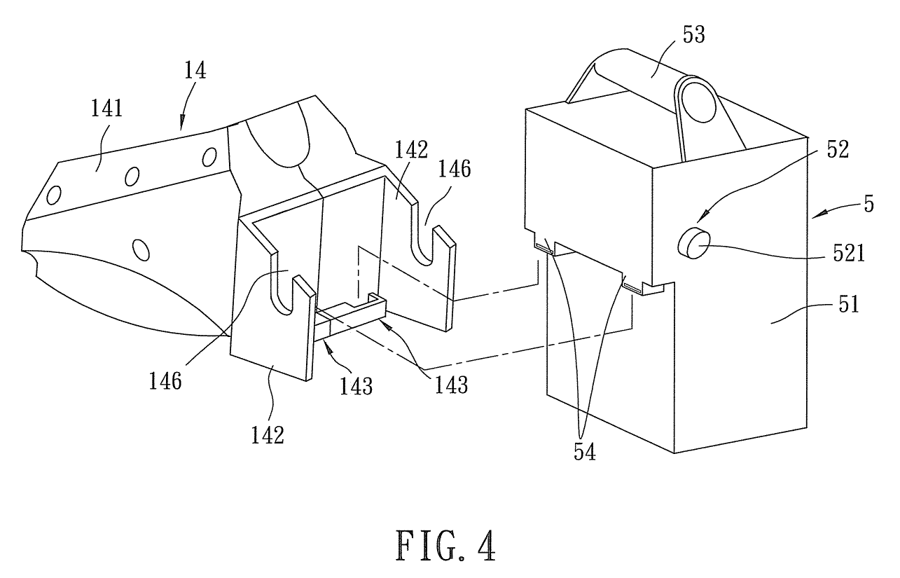

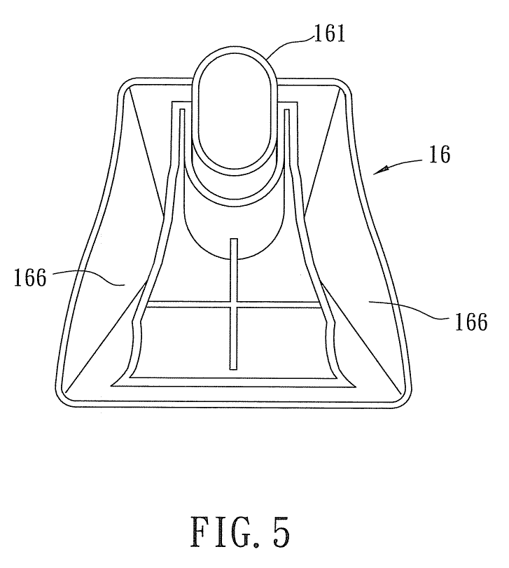

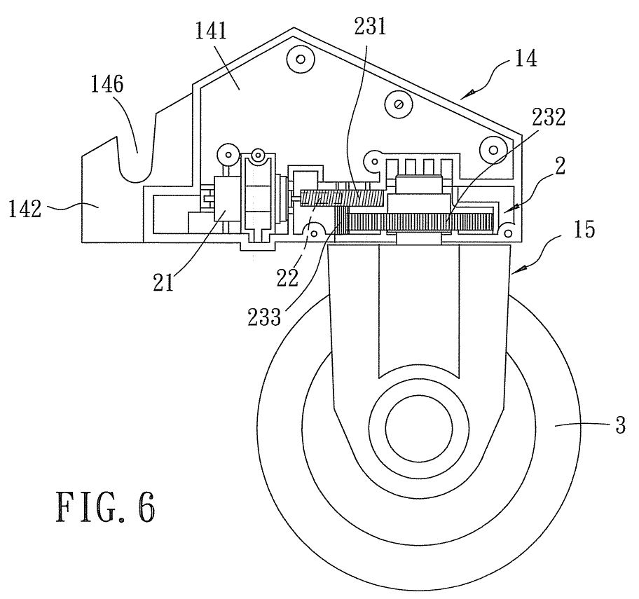

Referring to FIGS. 1 to 6, the preferred embodiment of a golf bag cart according to this invention comprises a cart unit 1 adapted for placing a golf bag (not shown) thereon, an electric drive unit 2, a rear wheel unit 4 connected to the cart unit 1, an electrically operable power front wheel unit 3 coupled to the cart unit 1 and disposed forwardly of the rear wheel unit 4, and a power supply unit 5 provided on the cart unit 1 and electrically coupled to the power front wheel unit 3 and the electric drive unit 2. The power front wheel unit 3 is electrically operable to cooperate with the rear wheel unit 4 for moving the cart unit 1 on a ground surface. The power front wheel unit 3 is coupled rotatably to the cart unit 1 so as to be rotatable relative to the cart unit 1 about a normal axis that is normal to the ground surface, thereby permitting change in direction of movement of the cart unit 1 on the ground surface. The electric drive unit 2 is coupled to the power front wheel unit 3 for driving rotation of the power front wheel unit 3 about the normal axis.

In this embodiment, the rear wheel unit 4 includes two rear wheel supports 41 extending from the cart frame 11, and two rear wheels 43 respectively and rotatably mounted on the rear wheel supports 41.

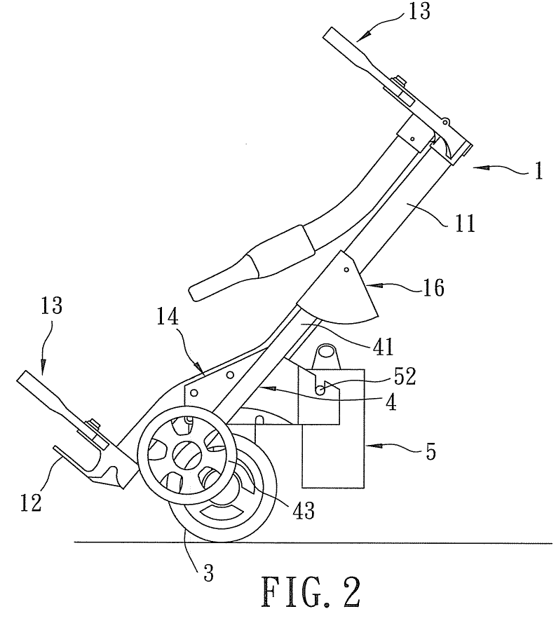

The cart unit 1 includes a cart frame 11, a support plate 12 connected to a bottom end of the cart frame 11, at least one retaining device 13 provided on the cart frame 11 for retaining the golf bag on the cart unit 1, a wheel support 14 mounted on the cart frame 11 with the use of screws (not shown), and a pivot support 16 disposed on the cart frame 11 and connected to the rear wheel supports 41. The pivot support 16 has a through-hole 161 through which the cart frame 11 extends, and a pair of recesses 166 into which the rear wheel supports 41 respectively extend. The recess 166 are disposed on left and right sides of the through-hole 161. The rear wheel supports 41 are pivoted to the pivot support 16. The recesses 166 guide pivoting movement of the rear wheel supports 41 in a front-rear direction such that the gold bag cart is convertible from an unfolded state (see FIG. 1) to a folded state (see FIG. 2).

The wheel support 14 has the power front wheel 3 coupled rotatably thereto, and has the electric drive unit 2 provided therein. The wheel support 14 includes a hollow base 141 mounted on the cart frame 11, and at least one first mounting portion 142 provided on the base 141. The power supply unit 5 includes a power supply body 51, at least one second mounting portion 52 disposed on the power supply body 51 for engaging releasably the at least one first mounting portion 142, and a handle 53 provided on the power support body 51.

In this embodiment, the wheel support 14 includes two of the first mounting portions 142, and the power supply unit 5 includes two of the second mounting portions 52 disposed on left and right sides of the power supply body 51, respectively. In this embodiment, the golf bag cart includes two of the retaining devices 13 respectively disposed on the cart frame 11 proximate to and distal from the support plate 12. Also, in this embodiment, each of the first mounting portions 142 is formed with an upwardly extending notch 146 and each of the second mounting portions 52 is formed as a protrusion 521 that engages the notch 146 in a respective one of the first mounting portions 142. Accordingly, the power supply unit 5 is removably provided on the cart unit 1.

The wheel support 14 further includes a pair of spaced-apart first conductive parts 143 provided on the base 141, and the power supply unit 5 further includes a pair of spaced-apart second conductive parts 54 that are provided on the power supply body 51 for establishing electrical connection with a corresponding one of the first conductive parts 143. In this embodiment, each of the first conductive parts 143 is a female part, and each of the second conductive parts 54 is a male part that extends downwardly into the corresponding one of the first conductive parts 143. By virtue of the first and second conductive parts 143, 54, electrical connection between the power supply unit 5 and each of the power front wheel unit 3 and the electric drive unit can be established when the power supply unit 5 is coupled to the wheel support 14.

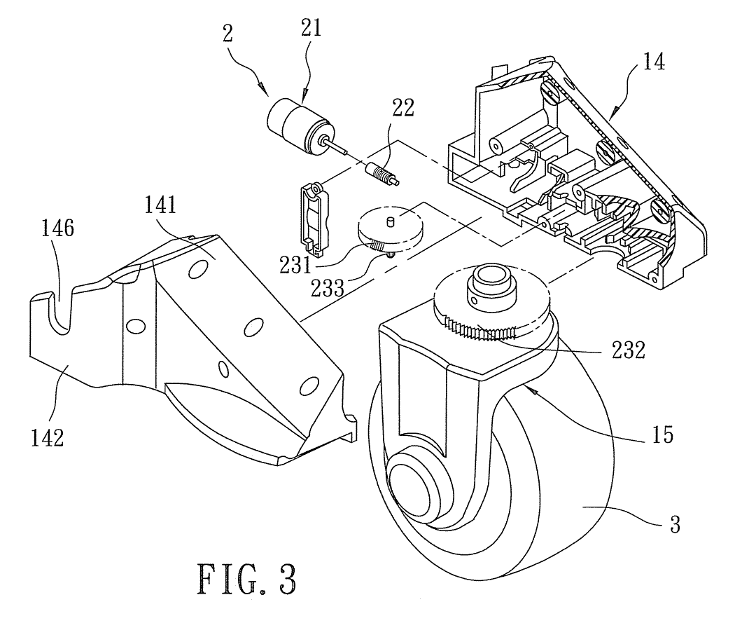

Furthermore, as shown in FIG. 3, the power front wheel unit 3 includes a driven gear 232 rotatably retained on the wheel support 14 and rotatable about the normal axis, and a bracket 15 that connects the power front wheel unit 3 to the driven gear 232. In this embodiment, the bracket 15 is L-shaped. The power front wheel unit 3 is one that includes an internal motor for driving rotation of the same about a wheel axis. Since the feature of the invention does not reside in the specific configuration of the power front wheel unit 3, further details of the same are omitted herein for the sake of brevity. The electric drive unit 2 includes a motor 21 with a drive component 22, a driving gear 231 that meshes with the drive component 22, and a coupling gear 233 that projects from one side of the driving gear 231 at a position offset from a gear axis of the driving gear 231 and that meshes with the driven gear 232. Due to the presence of the electric drive unit 2, the power front wheel unit 3 can be controlled to rotate about the normal axis for controlling the direction of movement of the car unit 1 on the ground surface.

In summary, the gold bag cart of the present invention is simple in construction and has a compact folded size since, instead of driving the rear wheel unit 4 (two rear wheels 43) as taught in the prior art, a power front wheel unit 3 associated operably with an electric drive unit 2 for direction control is utilized. In addition, with the removable design of the power supply unit 5, transport of the golf bag cart is facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A golf bag cart comprising:
a cart unit adapted for placing a golf bag thereon;
a rear wheel unit connected to said cart unit;
an electrically operable power front wheel unit coupled to said cart unit and disposed forwardly of said rear wheel unit, said power front wheel unit being electrically operable to cooperate with said rear wheel unit for moving said cart unit on a ground surface, said power front wheel unit being coupled rotatably to said cart unit so as to be rotatable relative to said cart unit about a normal axis that is normal to the ground surface, thereby permitting change in direction of movement of said cart unit on the ground surface; and
an electric drive unit disposed on said cart unit and coupled to said power front wheel unit for driving rotation of said power front wheel unit about the normal axis.

2. The golf bag cart as claimed in claim 1, further comprising a power supply unit provided on said cart unit and electrically coupled to said power front wheel unit and said electric drive unit.

3. The golf bag cart as claimed in claim 2, wherein said cart unit includes a cart frame, and a wheel support mounted on said cart frame and having said power front wheel unit coupled rotatably thereto,
said wheel support including a base mounted on said cart frame, and at least one first mounting portion provided on said base,
said power supply unit including a power supply body, and at least one second mounting portion disposed on said power supply body for engaging releasably said at least one first mounting portion.

4. The golf bag cart as claimed in claim 3, wherein said wheel support includes two of said first mounting portions, said power supply unit including two of said second mounting portions, each of said first mounting portions being formed with a notch, each of said second mounting portions being formed as a protrusion that engages said notch in a respective one of said first mounting portions.

5. The golf bag cart as claimed in claim 3, wherein said wheel support further includes a pair of spaced-apart first conductive parts provided on said base, and said power supply unit further includes a pair of spaced-apart second conductive parts that are provided on said power supply body for establishing electrical connection with a corresponding one of said first conductive parts.

6. The golf bag cart as claimed in claim 5, wherein each of said first conductive parts is a female part, and each of said second conductive parts is a male part that extends into the corresponding one of said first conductive parts.

7. The golf bag cart as claimed in claim 1, wherein:
said power front wheel unit includes a driven gear rotatably retained on said cart unit and rotatable about the normal axis; and
said electric drive unit includes a motor with a drive component, a driving gear that meshes with said drive component, and a coupling gear that projects from one side of said driving gear at a position offset from a gear axis of said driving gear and that meshes with said driven gear.
